(19) United States
(12) Patent Application Publication
(10) Pub. No.: US 2025/0239731 A1
(43) Pub. Date: Jul. 24, 2025

(54) BATTERY CELL INCLUDING A SNAP-FIT INSULATOR

(71) Applicant: GM Global Technology Operations LLC, Detroit, MI (US)

(72) Inventors: Raghavendra Saikrishna Keerthi Manda, Northville, MI (US); Subrahmanyam Goriparti, Troy, MI (US); Stephanie Girges, Windsor (CA)

(21) Appl. No.: 18/418,615

(22) Filed: Jan. 22, 2024

(51) Int. Cl. H01M 50/463; B60L 50/64; H01M 50/411; H01M 50/46

(52) U.S. Cl. CPC H01M 50/463; B60L 50/64; H01M 50/411; H01M 50/46; H01M 2220/20

(57) ABSTRACT

A battery cell for a rechargeable energy storage system includes a cell can including a base wall and a top wall extending between and connecting the first side wall and the second side wall. The cell can includes an internal storage volume. A cell stack is arranged in the internal storage volume. The cell stack includes a base surface, a first side surface, a second side surface, and a top surface. An insulator is arranged between the top surface and the top wall. The insulator includes an insulator surface. The insulator surface includes a first end and a second end. The insulator surface further includes a first end member projecting from the first end along the first side surface and a second end member extending from the second end along the second side surface. The insulator is snap-fittingly attached to the cell stack.

### INTRODUCTION

The subject disclosure relates to the art of vehicles and, more particularly, to a vehicle including a battery assembly having a battery cell with a snap-fit insulator.

Many modern vehicles include rechargeable energy storage systems that provide motive power to a drive unit. The drive unit provides motive power to one or more vehicle wheels. The rechargeable energy storage system typically includes battery cells that store and release electrical energy. Each cell includes a cathode and an anode that are insulated one from another by a separator. An electrical storage media is arranged in the cell and connected to the cathode and the anode.

The electrical storage media is typically arranged in a cell can that supports the cathode and anode. The cell can is typically filled with an electrolyte that insulates the electrical storage media. The cell can includes a fill opening through which the electrolyte is introduced into the cell can. Often times, the electrolyte concentrates at the fill opening leading to a weak wicking or absorption rate. The weak absorption rate typically leads to a multi-day fill process for the cell can in order to achieve desired insulating properties. Accordingly, it would be desirable to provide a system that facilitates complete filling of the cell can with electrolyte in a shorter time period.

### SUMMARY

A battery cell for a rechargeable energy storage system, in accordance with a non-limiting example, includes a cell can including a base wall, a first side wall, a second side wall, and a top wall extending between and connecting the first side wall and the second side wall. The cell can includes an internal storage volume. A cell stack is arranged in the internal storage volume. The cell stack includes a base surface, a first side surface, a second side surface, and a top surface that is spaced from the top wall. An insulator is arranged between the top surface and the top wall. The insulator includes an insulator surface extending along the top surface. The insulator surface includes a first end positioned at the first side surface and a second end positioned at the second side surface. The insulator surface further includes a first end member projecting from the first end along the first side surface and a second end member extending from the second end along the second side surface. The insulator is snap-fittingly attached to the cell stack.

In addition to one or more of the features described herein the insulator surface includes a plurality of openings.

In addition to one or more of the features described herein the insulator surface includes a plurality of raised ridges.

In addition to one or more of the features described herein the top surface of the cell can includes an electrolyte fill port.

In addition to one or more of the features described herein the insulator surface includes a first portion, a second portion, and an apex portion, the first portion extending from the first end to the apex portion at a first angle and the second portion extending from the second end to the apex portion at a second angle.

In addition to one or more of the features described herein the first angle is distinct from the second angle.

In addition to one or more of the features described herein the electrolyte fill port is aligned with the apex portion of the insulator.

In addition to one or more of the features described herein a stand-off is arranged between the first portion and the top surface of the cell stack.

In addition to one or more of the features described another stand-off is arranged between the second portion and the top surface of the cell stack pack.

In addition to one or more of the features described herein the insulator is formed from one of a plastic material and a plastic composite material.

A vehicle, in accordance with a non-limiting example, includes a body, an electric drive unit supported in the body, and a battery assembly supported in the body and electrically connected to the electric drive unit. The battery assembly including a plurality of battery cells, each of the plurality of battery cells includes a cell can including a base wall, a first side wall, a second side wall, and a top wall extending between and connecting the first side wall and the second side wall. The cell can includes an internal storage volume. A cell stack is arranged in the internal storage volume. The cell stack includes a base surface, a first side surface, a second side surface, and a top surface that is spaced from the top wall. An insulator is arranged between the top surface and the top wall. The insulator includes an insulator surface extending along the top surface. The insulator surface includes a first end positioned at the first side surface and a second end positioned at the second side surface. The insulator surface further includes a first end member projecting from the first end along the first side surface and a second end member extending from the second end along the second side surface. The insulator is snap-fittingly attached to the cell stack.

In addition to one or more of the features described herein the insulator surface includes a plurality of openings.

In addition to one or more of the features described herein the insulator surface includes a plurality of raised ridges.

In addition to one or more of the features described herein the top surface of the cell can includes an electrolyte fill port.

In addition to one or more of the features described herein the insulator surface includes a first portion, a second portion, and an apex portion, the first portion extending from the first end to the apex portion at a first angle and the second portion extending from the second end to the apex portion at a second angle.

In addition to one or more of the features described herein the first angle is distinct from the second angle.

In addition to one or more of the features described herein the electrolyte fill port is aligned with the apex portion of the insulator.

In addition to one or more of the features described herein a stand-off is arranged between the first portion and the top surface of the cell stack.

In addition to one or more of the features described herein another stand-off is arranged between the second portion and the top surface of the cell stack pack.

In addition to one or more of the features described herein the insulator is formed from one of a plastic material and a plastic composite material.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a rechargeable energy storage system (RESS) having a battery cell, in accordance with a non-limiting example;

FIG. 2 is a disassembled view of the RESS of FIG. 1 having a plurality of battery cells provided with a snap-fit insulator, in accordance with a non-limiting example;

FIG. 3 is a cross-sectional view of one of the plurality of battery cells of FIG. 2 illustrating the snap-fit insulator, in accordance with a non-limiting example;

FIG. 4 is a left side perspective view of the snap-fit insulator of FIG. 3, in accordance with a non-limiting example;

FIG. 5 is a right side perspective view of the snap-fit insulator of FIG. 3, in accordance with a non-limiting example;

FIG. 6 is a right side perspective view of a snap-fit insulator including overflow barriers, in accordance with a non-limiting example;

FIG. 7 is a perspective view of a snap-fit insulator, in accordance with another non-limiting example; and

FIG. 8 is a perspective view of a snap-fit insulator, in accordance with yet another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

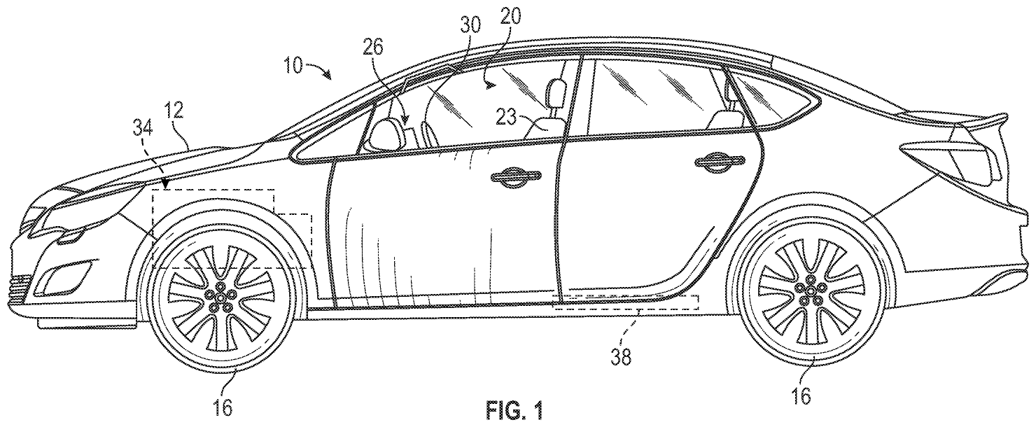

A vehicle, in accordance with a non-limiting example, is indicated generally at 10 in FIG. 1. Vehicle 10 includes a body 12 supported on a plurality of wheels 16. Body 12 defines, in part, a passenger compartment 20 having seats 23 positioned behind a dashboard 26. A steering control 30 is arranged between seats 23 and dashboard 26. Steering control 30 is operated to control the orientation of select ones of the plurality of wheels 16. Vehicle 10 includes an electric drive unit 34 that provides power to one or more of the plurality of wheels 16.

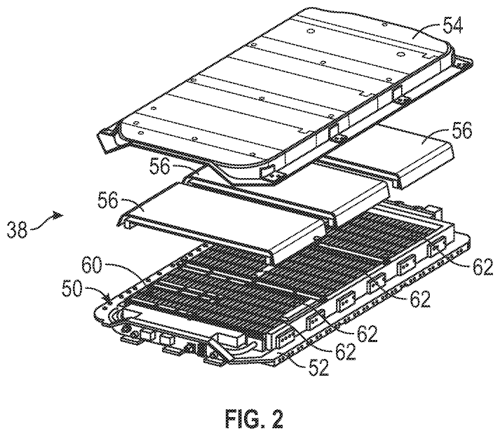

A rechargeable energy storage system (RESS) or battery assembly 38 is arranged in body 12 and provides power to electric drive unit 34. At this point, it should be understood that the location of electric drive unit 34 and battery assembly 38 may vary. As shown in FIG. 2, RESS 38 includes a housing 50 having a base 52, an outer cover 54, and a number of inner covers 56. Inner covers 56 shield and protect a plurality of battery cells 60 arranged in a number of adjacent rows 62 on base 52.

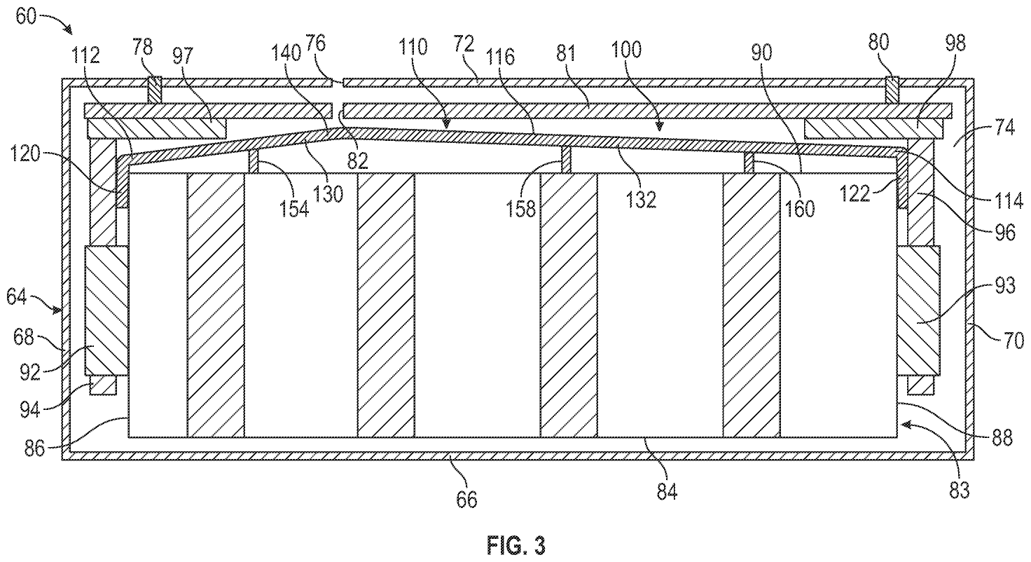

Reference will now follow to FIG. 3 in describing one of the plurality of battery cells 60 in accordance with a non-limiting example. Battery cell 60 includes a cell can 64 having a base wall 66, a first side wall 68, a second side wall 70, and a top wall 72. Cell can 64 includes an internal storage volume 74. Top wall 72 includes an electrolyte fill port 76 that provides a pathway for electrolyte (not shown) to flow into internal storage volume 74. Top wall 72 also supports a first terminal or cathode 78 and a second terminal or anode 80. First terminal 78 and second terminal 80 are connected to a top cap 81 that runs substantially parallel to top wall 72. Top cap 81 includes an opening 82 that is aligned with electrolyte fill port 76. A cell stack 83 is arranged in internal storage volume 74 and connected to first terminal 78 and second terminal 80 as will be discussed herein.

In a non-limiting example, cell stack 83 includes a base surface 84 that may rest on or near base wall 66, a first side surface 86, a second side surface 88, and a top surface 90. Cell stack 83 includes a first electrode tab 92 extending from first side surface 86 and a second electrode tab 93 extending from second side surface 88. A first current collector 94 is connected to first electrode tab 92 and a second current collector 96 is connected to second electrode tab 93. First current collector 94 is electrically connected to first terminal 78 through a first current collector isolator 97 and second current collector 96 is electrically connected to second terminal 80 through a second current collector isolator 98.

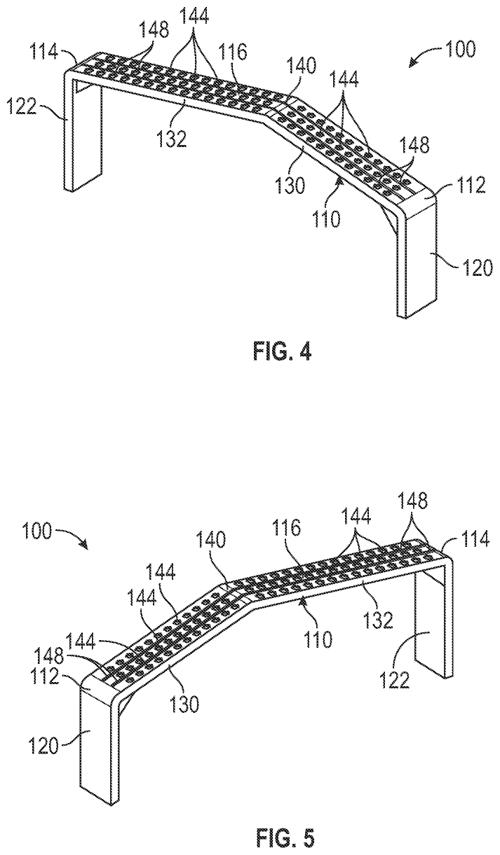

In a non-limiting example, an insulator 100 is arranged between top surface 90 and top cap 81. Insulator 100 isolates cell stack 83 from top cap 81 along with first terminal 78 and second terminal 80. As shown in FIGS. 4 and 5, insulator 100 includes an insulator member 110 having a first end 112, a second end 114, and an insulator surface 116 that extends between first end 112 and second end 114. Insulator 100 includes a first end member 120 connected to and extending from first end 112 and a second end member 122 connected to and extending from second end 114. Insulator 100 is sized such that first end member 120 engages first side surface 86 of cell stack 83 and second end member 122 engages second side surface 88 of cell stack 83 creating a snap-fit interface with cell stack 83.

In a non-limiting example, insulator surface 116 includes a first portion 130 extending from first end member 120 at first side surface 86 of cell stack 83 at a first angle and a second portion 132 extending from second end member 122 at second side surface 88 of cell stack 83 at a second angle. In a non-limiting example, the first angle and the second angle are different. First portion 130 and second portion 132 meet at an apex portion 140. In the non-limiting example shown, apex portion 140 is substantially aligned with electrolyte fill port 76.

In a non-limiting example, insulator surface 116 includes a plurality of openings 144 that allow electrolyte introduced into electrolyte fill port 76 to flow into internal storage volume 74. The angles of first portion 130 and second portion 132 together with the plurality of openings 144 facilitate a more uniform distribution of electrolyte into internal storage volume 74 so as to increase an overall absorption rate of cell stack 83. Insulator surface 116 also includes one or more raised ridges 148 that extend between first end 112 and second end 114. Raised ridges 148 further enhance an overall uniform distribution of electrolyte into internal storage volume 74.

In a non-limiting example, Insulator 100 may include a first stand-off 154, FIG. 3, that supports first portion 130 as well as a second stand-off 158 and a third stand-off 160 that support second portion 134. First stand-off 154 is integrally formed with insulator surface 116 and extends between first portion 130 and top surface 90 of cell stack 83. Second stand-off 158 and third stand-off 160 are integrally formed with insulator surface 116 and extend between second portion 134 and top surface 90. First stand-off 154, second stand-off 158, and third stand-off 160 provide structural support for insulator 100.

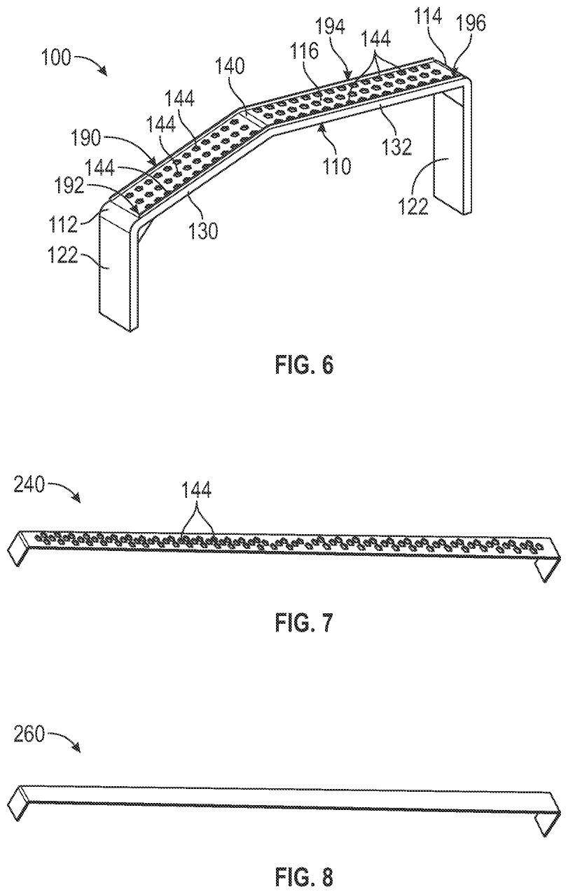

In a non-limiting example, insulator 100 is formed from a plastic material or a plastic composite material having a selected amount of flexibility in order to facilitate the snap-fit connection. The amount of flexibility may vary depending on cell stack geometry and a level of gripping force desired for a particular application. In addition, as shown in FIG. 6, it should be understood that insulator 100 may include overflow barriers such as indicated at 190 and 192 and 194 and 196 that guide electrolyte to outer ends 112, 114 (not separately labeled) of first portion 130 and second portion 132 respectively as shown in FIG. 6. Further, while described as including angled portions, an insulator may be substantially linear such as shown at 240 in FIG. 7. Still further, while shown as including openings 144, an insulator 260 may be formed without openings as shown in FIG. 8. Insulators 240 and/or 260 may be angled or formed without angles as shown.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

The terms “about” and “substantially” are intended to include the degree of error associated with measurement of the particular quantity based upon the equipment available at the time of filing the application. For example, “about” and/or “substantially” can include a range of +8% or 5%, or 2% of a given value.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell for a rechargeable energy storage system comprising:
a cell can including a base wall, a first side wall, a second side wall, and a top wall extending between and connecting the first side wall and the second side wall, the cell can including an internal storage volume;
a cell stack arranged in the internal storage volume, the cell stack including a base surface, a first side surface, a second side surface, and a top surface that is spaced from the top wall; and
an insulator arranged between the top surface and the top wall, the insulator including an insulator surface extending along the top surface, the insulator surface including a first end positioned at the first side surface and a second end positioned at the second side surface, the insulator surface further including a first end member projecting from the first end along the first side surface and a second end member extending from the second end along the second side surface, the insulator being snap-fittingly attached to the cell stack.

2. The battery cell according to claim 1, wherein the insulator surface includes a plurality of openings.

3. The battery cell according to claim 1, wherein the insulator surface includes a plurality of raised ridges.

4. The battery cell according to claim 1, wherein the top surface of the cell can includes an electrolyte fill port.

5. The battery cell according to claim 4, wherein the insulator surface includes a first portion, a second portion, and an apex portion, the first portion extending from the first end to the apex portion at a first angle and the second portion extending from the second end to the apex portion at a second angle.

6. The battery cell according to claim 5, wherein the first angle is distinct from the second angle.

7. The battery cell according to claim 5, wherein the electrolyte fill port is aligned with the apex portion of the insulator.

8. The battery cell according to claim 5, further comprising a stand-off arranged between the first portion and the top surface of the cell stack.

9. The battery cell according to claim 8, further comprising another stand-off arranged between the second portion and the top surface of the cell stack, pack.

10. The battery cell according to claim 1, wherein the insulator is formed from one of a plastic material and a plastic composite material.

11. A vehicle comprising:
a body;
an electric drive unit supported in the body;
a battery assembly supported in the body and electrically connected to the electric drive unit, the battery assembly including a plurality of battery cells, each of the plurality of battery cells comprising:
a cell can including a base wall, a first side wall, a second side wall, and a top wall extending between and connecting the first side wall and the second side wall, the cell can including an internal storage volume;
a cell stack arranged in the internal storage volume, the cell stack including a base surface, a first side surface, a second side surface, and a top surface that is spaced from the top wall; and
an insulator arranged between the top surface and the top wall, the insulator including an insulator surface extending along the top surface, the insulator surface including a first end positioned at the first side surface and a second end positioned at the second side surface, the insulator surface further including a first end member projecting from the first end along the first side surface and a second end member extending from the second end along the second side surface, the insulator being snap-fittingly attached to the cell stack.

12. The vehicle according to claim 11, wherein the insulator surface includes a plurality of openings.

13. The vehicle according to claim 11, wherein the insulator surface includes a plurality of raised ridges.

14. The vehicle according to claim 11, wherein the top surface of the cell can includes an electrolyte fill port.

15. The vehicle according to claim 14, wherein the insulator surface includes a first portion, a second portion, and an apex portion, the first portion extending from the first end to the apex portion at a first angle and the second portion extending from the second end to the apex portion at a second angle.

16. The vehicle according to claim 15, wherein the first angle is distinct from the second angle.

17. The vehicle according to claim 15, wherein the electrolyte fill port is aligned with the apex portion of the insulator.

18. The vehicle according to claim 15, further comprising a stand-off arranged between the first portion and the top surface of the cell stack.

19. The vehicle according to claim 18, further comprising another stand-off arranged between the second portion and the top surface of the cell stack, pack.

20. The vehicle according to claim 11, wherein the insulator is formed from one of a plastic material and a plastic composite material.
